(19) United States
(12) Patent Application Publication
(10) Pub. No.: US 2004/0231539 A1
(43) Pub. Date: Nov. 25, 2004

(54) Flexographic printing formes

(75) Inventor: Geoffrey Clinton, Hertfordshire (GB)

Correspondence Address: SUGHRUE MION, PLLC, 401 Castro Street, Ste 220, Mountain View, CA, 94041-2007, US

(73) Assignee: INNOVATIVE ELASTICS LIMITED, Limerick (IE)

(21) Appl. No.: 10/475,762

(22) PCT Filed: Apr. 18, 2002
(86) PCT No.: PCT/EP02/04855

(30) Foreign Application Priority Data
Apr. 19, 2001 (GB) 0109645.2

(51) Int. Cl. B41C 1/00

(52) U.S. Cl. 101/401.1

(57) ABSTRACT

Elastomeric materials have long been used to produce printing blocks, printing rollers, printing formes and elastomeric covered printing sleeves for flexographic printing. A suitable and commonly used elastomeric material is natural rubber. According to one aspect of the present invention such a flexographic printing member comprises a printing surface having raised regions (2) and sunken regions (1) wherein one of the raised regions or sunken regions (2) is formed of ink accepting material and the other (1) is formed of ink repelling material. The area of the forme onto which the ink is held is therefore limited essentially to the tops of the raised regions (2) since it is repelled by the side walls of the raised regions. This considerably reduces the “dot gain” that otherwise takes place.

### FIELD OF INVENTION

The present invention relates to the field of printing formes and in particular to flexbgraphic printing formes.

### BACKGROUND OF INVENTION

Elastomeric materials have long been used to produce printing blocks, printing rollers, printing formes and elastomeric covered printing sleeves for flexographic printing. A suitable and commonly used elastomeric material is natural rubber. A printing forme can be formed from a sheet or covering of natural rubber. The inked pattern that is required to be transferred onto a substrate by the flexographic printing forme is typically formed by removing areas of the surface of the printing forme where the transfer of ink is not required, to leave a raised pattern corresponding to the image to be printed. Ink is then coated on the surface of the raised pattern via an Anilox roller and the pattern transferred onto the desired substrate by contacting the raised inked surface of the forme with the substrate.

In order to be effective the raised surface of the elastomeric compound must have appropriate chemical and physical properties. The elastomeric surface must be such that printing inks are able to form a well defined coating on it. Such a surface is often referred to as“ink accepting”.

The removal of areas of the elastomeric surface can be accomplished in a number of ways, such as by hand engraving, machining or laser ablation.

Using a flexographic printing technique it is impossible to apply printing inks from inking rollers in varying thicknesses to different parts of a printing surface. Ink is either transferred fully or not at all. Thus, in order to give the impression of tonal variation within an image, a system of printing dots of various sizes is employed. If the individual dots are small enough to be indistinguishable individually by the eye and non-inked portions of the substrate fill the spaces between the dots, the illusion of a tonal image is created. This is often called halftone printing.

Flexographic printing is cheaper than other leading printing techniques, such as gravure printing and lithographic printing. Flexographic printing has the advantage that it can be used directly on non-flat substrates and is the fastest growing printing method worldwide. A weakness of flexographic printing, in comparison with other techniques, is that it suffers from high dot gain over the full tonal range which is difficult to control. In the case of the lowest printing tone it is far too high in density, typically a 3% dot by surface area prints at the equivalent of 15-20% by surface area. Dot gain occurs because too much ink is transferred from the dots to the recording medium.

The main mechanism responsible for high dot gain in flexographic printing is that ink present on the sides of the dots on the printing forme is transferred to the recording medium. When ink is transferred from an inking roller to the surface of the printing forme, not only is it transferred to the raised printing surface but some also is transferred to the sides of the raised printing surface. Partly this results from the depth of ink being supplied from the inking roller and partly by the compression of the raised surface by contact with the inking roller increasing the area of contact between the raised surface and the inking roller. The ink is then transferred from the dot sides to a recording medium by a wick-like action. Anilox rollers are used to meter the amount of ink that is transferred to the flexographic forme but these do not prevent ink from being transferred to the sides of dots and building up over successive print cycles.

### SUMMARY OF THE INVENTION

According to one aspect of the present invention a flexographic printing member having a main body made from an elastomeric material comprises a printing surface having raised regions and sunken regions wherein one of the raised regions and the sunken regions is formed of ink accepting material and the other is formed of ink repelling material.

A printing member in which the raised regions are formed of ink accepting material and the sunken regions are formed of ink repelling material, holds ink on the raised regions but rejects ink in the sunken regions. The ink accepting material is confined to the raised regions as a thin layer. The area of the forme onto which the ink is held is therefore limited essentially to the tops of the raised regions since it is repelled by the side walls of the raised regions. This limits the amount of ink held on the forme and so the amount of ink that can be transferred to a substrate. When printing using-a halftone pattern, ink is not held on the sides of dots but only on the surface of the thin layer of ink accepting material capping the dots. Accordingly this considerably reduces the “dot gain” that takes place.

A printing member in which the sunken regions are formed of ink accepting material and the raised regions are formed of ink repelling material, holds ink in the sunken regions and not on the raised regions. This is contrary to conventional flexographic printing where it is always the raised regions which hold the ink. The amount of ink held on the forme is therefore limited to the surface area of the sunken regions. The sunken regions are preferably only a few microns below the raised regions and the elastomeric material is sufficiently deformable so that when the printing member is pressed into contact with an inking roller, ink contacts and is held on the sunken regions. Likewise, when the inked printing member is pressed into contact with a substrate, the printing member is sufficiently deformable so that ink is transferred to the substrate from the sunken regions.

Preferably, the elastomeric material has a Shore A hardness of less than 80. Preferably, for printing on flat substrates the elastomeric material has a Shore A hardness of between 55 and 65. For printing on corrugated substrates the elastomeric material preferably has a Shore A hardness of between 20 and 30.

The elastomeric body can be formed from vulcanised rubbers, and/or blends of vulcanised rubbers such as Natural Rubber (NR), Polyisoprene, Acrylonitrile-Butadiene Rubber (NBR), Styrene Butadiene Rubber (SBR), Ethylene Propylene Diene Rubbers (EPDM), Butadiene Rubber, Butyl Rubber, Silicone Rubbers and Polysulphide Rubbers.

The elastomeric body can also be formed from Thermoplastic Elastomers (TPE's) and/or blends of thermoplastic elastomers, such as block copolymers of vinyl aromatic hydrocarbons and conjugated olefins and their hydrogenated derivatives, block polyurethane copolymers, block polyetheresters and polyetheramides.

Other possible materials for the elastomeric body include Thermoplastic Polyolefin Elastomers (TPO's) and Thermoplastic Polyolef in Vulcanisates (TPV's) and/or blends of TPO's and/or TPV's. It is possible to form the elastomeric body from blends or mixtures of vulcanised rubbers and/or TPE's and/or TPO's and/or other non-elastomeric polymers.

The printing member may have a form which is generally conventional. Thus it may be formed by a flat elastomeric body mounted on a metal or glass fibre substrate for use in a flat bed printing press or be formed by a flat elastomeric body mounted on a substrate for fitting to a rotary printing press. Alternatively, it may have a generally cylindrical form and in this case, the printing member may be a cylindrical roller having a metal core covered by the elastomeric body, or have the form of a sleeve which may or not include a metal or glass fibre substrate for fitting to a rotary printing press.

The printing member of the present invention offers more accurate ink transfer with low dot gain as compared with conventional flexographic printing formes. Ink is only transferred to the ink accepting regions of the flexographic forme, which correspond to areas that are desired to be printed. Excess ink on areas not desired to be printed, which is responsible for dot gain, is not taken by the flexographic forme. The present invention also renders expensive Anilox rollers used for metering the ink supply redundant. The flexographic forme of the present invention only holds ink on the ink accepting areas and so there is no need to meter and limit the supply of ink. Instead the printing forme can be inked directly from a standard inking roller chain or from an ink bath. The present invention improves both the quality and the cost/benefit economics of flexographic printing.

According to another aspect of the present invention a method of producing a flexographic printing member comprises the steps of:

forming a surface layer on an elastomeric member, the surface layer having different physical and/or chemical properties to the elastomeric member such that one of the elastomeric member and the surface layer is ink accepting and the other is ink repelling; and

selectively removing areas of the surface layer to expose underlying areas of the elastomeric member.

Preferably the surface layer is removed by ablation using a CO₂ laser, a YAG laser, laser diodes or photodiodes.

The thickness of the surface layer is preferably less than 1000 microns, more preferably less than 100 microns and most preferably less than 10 microns. The surface layer can be formed by modifying the elastomeric member, either chemically or physically. Chemical modifying processes include chlorination, bromination, fluorination, hydrogenation, ozonolysis, plasma polymerisation treatment, and modification by reactive chemicals e.g. grafting with monomers.

Suitable physical modification processes include plasma treatment, corona discharge, micro-etching, exposure to radiation, chemical cleaning and chemical hardening.

Alternatively a different material can be used for the surface layer formed by deposition or co-extrusion. Suitable techniques include painting, plating, Chemical Vapour Deposition (CVD), conformal coating, copolymerisation, plasma coating, vapour deposition polymerisation, extrusion coating, heat shrinking and radiation cured coating.

### BRIEF DESCRIPTION OF THE DRAWINGS

Particular embodiments of the present invention will now be described with reference to the accompanying drawings in which:

FIG. 1 is a scrap cross-section through an elastomeric forme including a surface layer;

FIG. 2 is a scrap cross-section through the elastomeric forme of FIG. 1 with portions of the surface layer and main body removed;

FIG. 3 is a scrap cross-section through an alternative printing forme; and

FIGS. 4a and 4b are scrap cross-sections through a further embodiment.

### DESCRIPTION OF PREPARED EMBODIMENTS

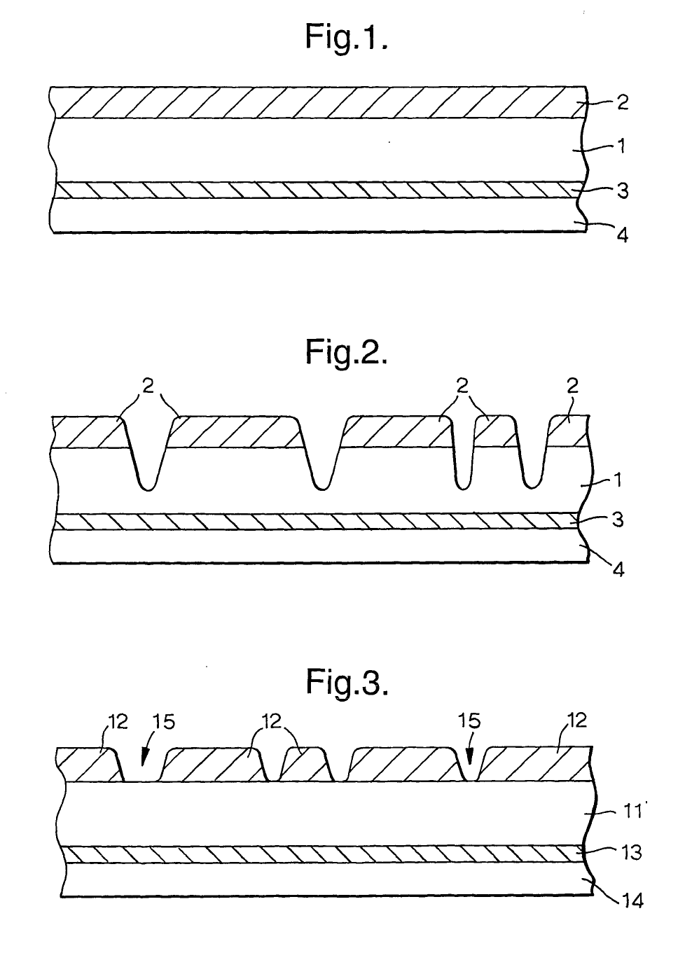

FIG. 1 shows an elastomeric forme comprising an elastomeric body 1 covered by a surface layer 2. The elastomeric body 1 has the ability to deform under stress and return to its original size and shape upon release of the stress. The elastomeric body 1 is formed on a stabilising layer 3 of Mylar (RTM) polyethylene teraphtlate and supported by a backing of metal such as aluminium or glass fibre reinforced plastics material. The forme may be flat or cylindrical.

FIG. 2 shows the elastomeric forme of FIG. 1 which has been ablated in accordance with a particular printing pattern. The main body 1 of the forme is formed from an ink repelling material such as silicone rubber. The surface layer 2 is formed of an ink accepting material. The layer 2 may be formed by a different material or the silicone rubber may be treated, for example by a plasma treatment such as described in U.S. Pat. No. 6,299,596, U.S. Pat. No. 6,200,626 or WO 0121691 to its properties so that it is ink accepting. The surface layer 2 and main body 1 have been removed in regions leaving raised columns or dots. Ink applied to the printing forme of FIG. 2 adheres only to the surface layer 2. The amount of ink transferred to the forme, and hence to the eventual substrate is limited by the area of remaining surface layer 2. This removes the need for an Anilox roll and reduces dot gain as compared with conventional flexographic printing formes.

FIG. 3 shows an alternative embodiment of a flexographic printing forme according to the present invention in which the material of the body 11 of the forme is ink accepting and the surface layer 12 is ink repelling. A suitable material for the body 11 is natural rubber, vulcanised at 145° C. for 30 minutes. The surface layer 12 may be an organosilicone layer formed by plasma coating but preferably is a silicone coating made by G.E. Silicones of Waterford, N.Y. 12188, USA under their designation SS6810.

The main body 11, stabilising layer 13 and backing 14 may comprise a conventional plate such as FP5001, FP2001, FP3001 or FP4001 manufactured by Fulflex Inc. of Middletown, R.I. 02840, USA. Only the surface layer is ablated by a YAG laser to expose areas of the underlying rubber body 1. The rubber body 1 is a few millimetres thick. The depth of the surface layer is about 8 microns. Ink transferred to the printing forme will adhere to the rubber body 1 on exposed regions 15 but will not adhere to the regions 12. The amount of ink received by the forme is limited to the volume of cavities 15. It is therefore not necessary to use an Anilox roller to apply the ink. During printing the ink in the cavities 15 is transferred to a substrate, such as flexible packaging made from polypropylene.

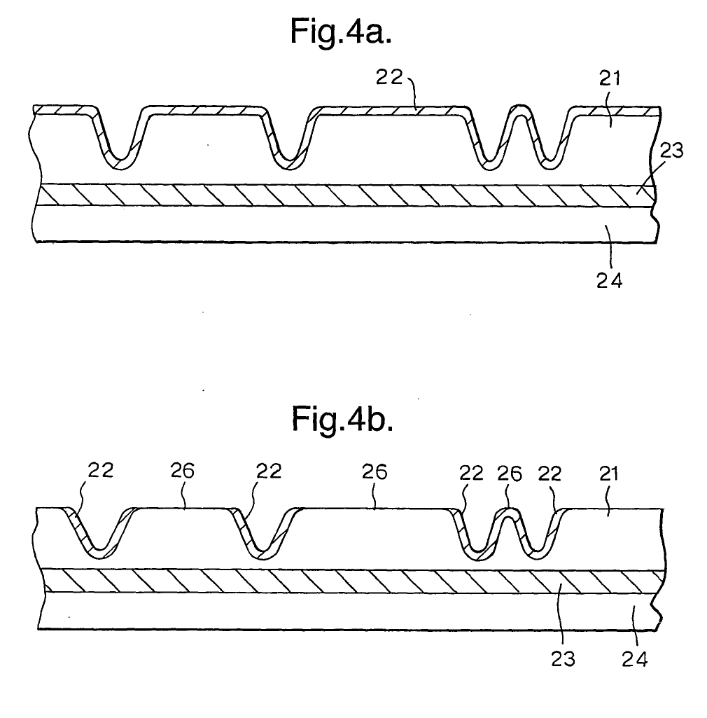

FIG. 4 shows a further embodiment of a flexographic printing forme according to the present invention. The main body 21 of the forme is made of an ink accepting material and again the basic plate may be a conventional plate such as FP5001 referred to above. The top surface of the forme is ablated by a laser according to a desired pattern to form raised areas and sunken pits. The top surface of the forme including the inside of the sunken pits is then coated with an ink rejecting material 22 such as PTFE, (polytetrafluro-ethylene) by plasma coating, or by the silicone material referred to above, as shown in FIG. 4a. Alternatively the top surface could be chemically modified to make it ink rejecting by exposure to plasma polymerisation. The top surface of the printing forme on the raised areas is then removed by an abrasion process to expose areas 26 of ink accepting material as shown in FIG. 4b. Ink transferred to the printing forme only adheres to the exposed ink accepting regions 26, thus limiting the amount of ink transferred to a substrate and again reducing dot gain.

1. A flexographic printing member having a main body (1) made from an elastomeric material comprising a printing surface having raised regions (2) and sunken regions (15) wherein one of the raised regions (2, 15) and the sunken regions is formed of ink accepting material and the other (15, 2) is formed of ink repelling material.

2. A printing member according to claim 1, in which the raised regions (2) are formed of ink accepting material and the sunken regions (1) are formed of ink repelling material, whereby, in use, ink is held on the raised regions (2) and rejected by the sunken regions (1) ink thereby being substantially confined to the tops of the raised regions (2).

3. A printing member according to claim 2, in which the layer of material (2) forming the tops of the raised regions is less than 10 microns thick.

4. A printing member according to claim 1, in which the sunken regions (15) are formed of ink accepting material and the raised regions (12) are formed of ink repelling material whereby, in use, ink is held in the sunken regions (15) and rejected from the raised regions (12), ink thereby being substantially confined to the surface area of the sunken regions (15).

5. A printing member according to claim 4, in which the sunken regions (15) are only a few microns below the raised regions (12) and the elastomeric material (11) is sufficiently deformable so that, in use, when the printing member is pressed into contact with an inking roller, ink contacts and is held on the sunken regions (15).

6. A printing member according to claim 1, in which the elastomeric material has a Shore A hardness of less than 80.

7. A printing member according to claim 6, in which, for printing on flat substrates the elastomeric material has a Shore A hardness of between 55 and 65 or for printing on corrugated substrates the elastomeric material has a Shore A hardness of between 20 and 30.

8. A method of producing a flexographic printing member comprising the steps of:
forming a surface layer (2, 12) on an elastomeric member (1, 11), the surface layer (2, 12) having different physical and/or chemical properties to the elastomeric member (1, 11) such that one of the elastomeric member and the surface layer is ink accepting and the other is ink repelling; and,
selectively removing areas of the surface layer (2, 12) to expose underlying areas of the elastomeric member (1, 11).

9. A method according to claim 8, in which the removal of the surface layer (2, 12) is by ablation using a CO₂ laser, a YAG laser, laser diodes or photodiodes.

10. A method according to claim 8, in which thickness of the surface layer (2, 12) is less than 1000 microns, preferably less than 100 microns and most preferably less than 10 microns.
